(19) United States
(12) Patent Application Publication
(10) Pub. No.: US 2017/0274505 A1
(43) Pub. Date: Sep. 28, 2017

(54) Cable Grasping Tool

(71) Applicant: Robert Weil, Hummelstown, PA (US)

(72) Inventor: Robert Weil, Hummelstown, PA (US)

(21) Appl. No.: 15/080,776

(22) Filed: Mar. 25, 2016

(51) Int. Cl. B25B 7/02

(52) U.S. Cl. CPC B25B 7/02

(57) ABSTRACT

A cable grasping tool for grasping brake and derailleur cables includes a pair of handles that is rigid. The handles are pivotally coupled and arcuate, such that the handles are opposing. Each of a pair of jaws is coupled to and extends from a first end of a respective handle. Each of a plurality of grasps is coupled to an inner edge of a respective jaw. The grasps are configured to selectively couple a brake cable and a derailleur cable of a velocipede. The handles are positionable with the jaws in an open configuration, such that a cable is insertable between the jaws. The handles are configured for inward pivoting by action of a user's hand, such that the plurality of grasps engage the cable and facilitate manipulation of the cable by the user.

### BACKGROUND OF THE DISCLOSURE

Field of the Disclosure

The disclosure relates to grasping tools and more particularly pertains to a new grasping tool for grasping brake and derailleur cables.

Summary of the Disclosure

An embodiment of the disclosure meets the needs presented above by generally comprising a pair of handles that is rigid. The handles are pivotally coupled and arcuate, such that the handles are opposing. Each of a pair of jaws is coupled to and extends from a first end of a respective handle. Each of a plurality of grasps is coupled to an inner edge of a respective jaw. The grasps are configured to selectively couple a brake cable and a derailleur cable of a velocipede. The handles are positionable with the jaws in an open configuration, such that a cable is insertable between the jaws. The handles are configured for inward pivoting by action of a user's hand, such that the plurality of grasps engage the cable and facilitate manipulation of the cable by the user.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a cable grasping tool according to an embodiment of the disclosure.

FIG. 2 is a front view of an embodiment of the disclosure.

FIG. 3 is a side view of an embodiment of the disclosure.

FIG. 4 is a side view of an embodiment of the disclosure.

FIG. 5 is an in-use view of an embodiment of the disclosure.

### DESCRIPTION OF THE PREFERRED EMBODIMENT

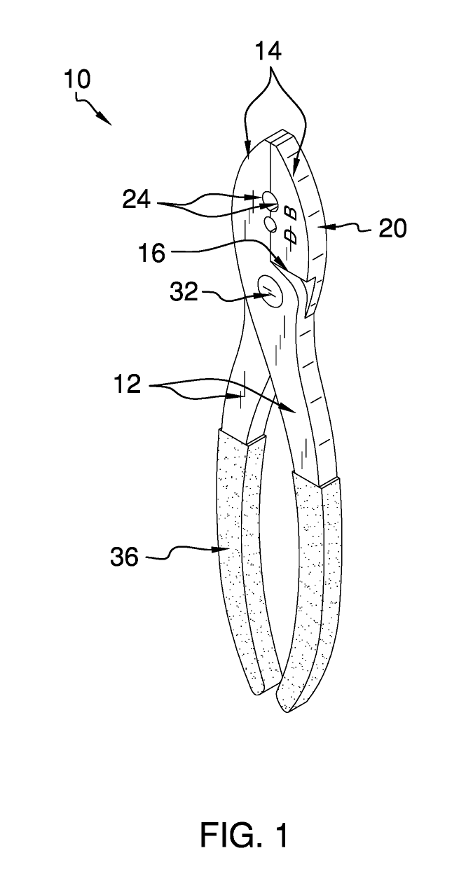

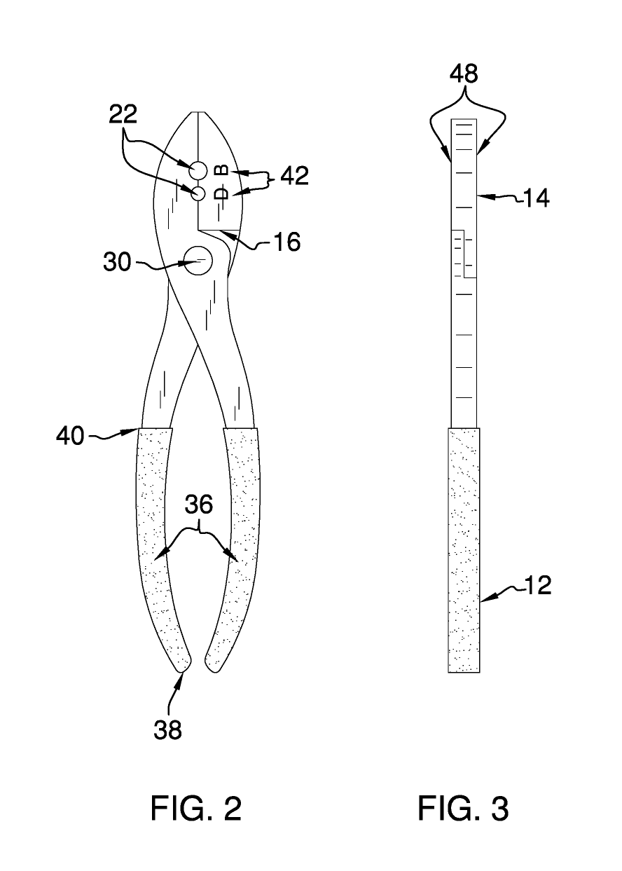

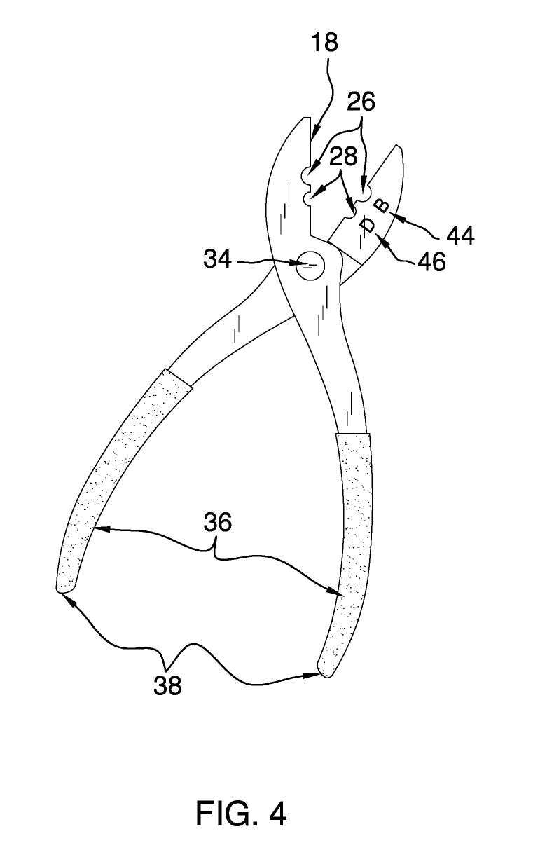

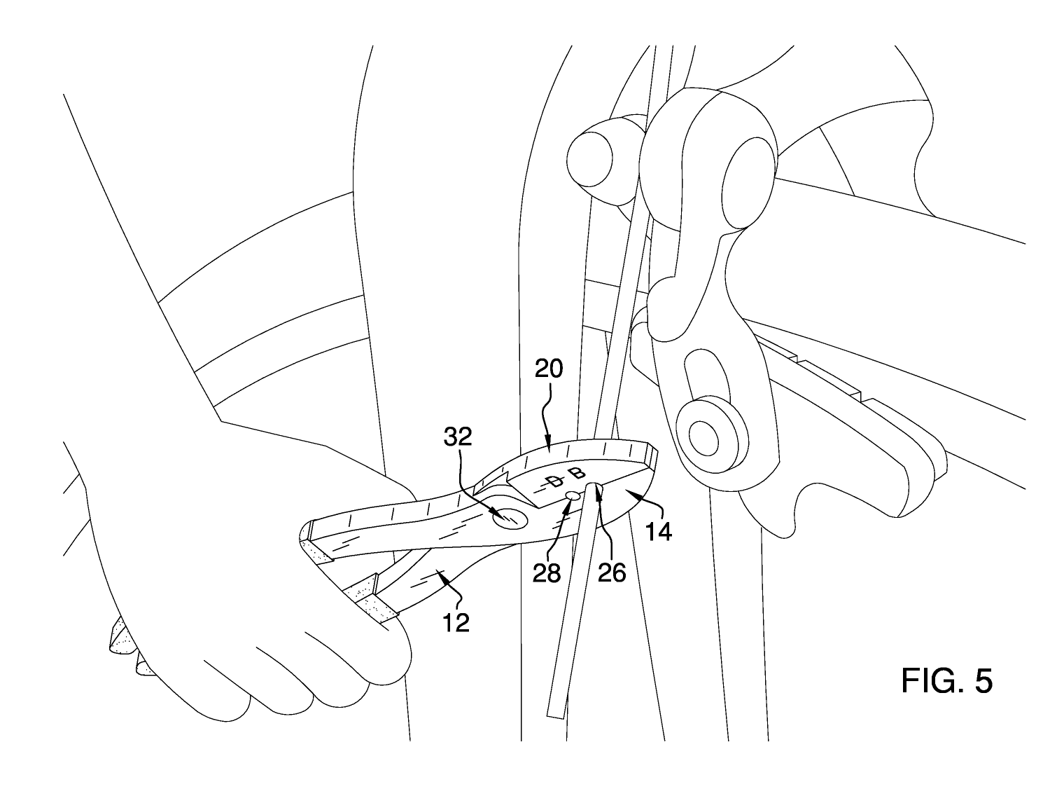

With reference now to the drawings, and in particular to FIGS. 1 through 5 thereof, a new grasping tool embodying the principles and concepts of an embodiment of the disclosure and generally designated by the reference numeral 10 will be described.

As best illustrated in FIGS. 1 through 5, the cable grasping tool 10 generally comprises a pair of handles 12 that is rigid. The handles 12 are pivotally coupled and arcuate, such that the handles 12 are opposing. Each of a pair of jaws 14 is coupled to and extends from a first end 16 of a respective handle 12. Each jaw 14 comprises an inner edge 18 that is substantially straight and planar. The inner edges 18 are adjacently positionable when the handles 12 are pivoted inwardly. Each jaw 14 comprises an outer edge 20 that is, preferably, arcuate.

Each of a plurality of grasps 22 is coupled to the inner edge 18 of a respective jaw 14. The grasps 22 are configured to selectively couple a brake cable and a derailleur cable of a velocipede. Each grasp 22 comprises a pair of cutouts 24 that is semicircular. Each cutout 24 is positioned in the inner edge 18 of a respective jaw 14, such that the cutouts 24 are opposingly positioned in the jaws 14.

Preferably, the plurality of grasps 22 comprises a pair of first cutouts 26 and a pair of second cutouts 28, which are semicircular. Each first cutout 26 is positioned in the inner edge 18 of a respective jaw 14, such that first cutouts 26 are opposingly positioned in the jaws 14. Preferably, each first cutout 26 has a radius of 0.50 to 0.75 millimeters. More preferably, each first cutout 26 has a radius of 0.60 to 0.70 millimeters.

Each second cutout 28 is positioned in the inner edge 18 of a respective jaw 14, such that second cutouts 28 are opposingly positioned in the jaws 14. Preferably, each second cutout 28 has a radius of 0.35 to 0.55 millimeters. More preferably, each second cutout 28 has a radius of 0.40 to 0.50 millimeters. Also preferably, the pair of first cutouts 26 is positioned distally from the pair of second cutouts 28 relative to the first ends 16 of the handles 12.

Each of a pair of pivot holes 30 is positioned through a respective handle 12 proximate to the first end 16 of the respective handle 12. A pivot pin 32 is positioned through each of the pair of pivot holes 30. Opposing flared ends 34 of the pivot pin 32 retain the pivot pin 32 within the pivot holes 30, such that the pair of handles 12 is pivotally coupled.

Each of a pair of grips 36 is coupled to a respective handle 12. The grips 36 are positioned on the handles 12 such that the grips 36 are configured to engage the fingers and a palm of a user's hand to prevent slippage of the handles 12. Preferably, each grip 36 extends from a second end 38 of a respective handle 12 to proximate to a midpoint 40 of the respective handle 12.

Each of a plurality of indicators 42 is coupled to a respective jaw 14 proximate to a respective grasp 22. The indicator 42 is positioned on the jaw 14 to notify the user of the intended usage of the grasp 22. Preferably, the plurality of indicators 42 comprises “B” labels 44 positioned proximate to the first cutouts 26 and “D” labels 46 positioned proximate to the second cutouts 28. Also preferably, the “B” labels 44 and the “D” labels 46 are engraved, and the plurality of indicators 42 is positioned on opposing faces 48 of a respective jaw 14.

In use, the handles 12 are positionable with the jaws 14 in an open configuration. A cable is insertable between the jaws 14, and the handles 12 are configured for inward pivoting by action of a user's hand. The pair of first cutouts 26 is configured to engage a brake cable and the pair of second cutouts 28 is configured to engage a derailleur cable to facilitate manipulation of brake and derailleur cables by the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cable grasping tool comprising:
a pair of handles, said handles being rigid, said handles being pivotally coupled, said handles being arcuate, such that said handles are opposing;
a pair of jaws, each said jaw being coupled to and extending from a first end of a respective said handle;
a plurality of grasps, each said grasp being coupled to an inner edge of a respective said jaw, said grasps being configured to selectively couple a brake cable and a derailleur cable of a velocipede;
wherein said handles are positionable with said jaws in an open configuration, such that a cable is insertable between said jaws, wherein said handles are configured for inward pivoting by action of a user's hand such that said plurality of grasps engage the cable and facilitate manipulation of the cable by the user.

2. The tool of claim 1, further including each said jaw comprising:
said inner edge being substantially straight, such that said inner edges are adjacently positionable when said handles are pivoted inwardly;
and
an outer edge, said outer edge being arcuate.

3. The tool of claim 2, further including each said grasp comprising a pair of cutouts, each said cutout being positioned in said inner edge of a respective said jaw, wherein said cutouts are opposingly positioned in said jaws, said cutouts being semicircular.

4. The tool of claim 2, further including said plurality of grasps comprising:
a pair of first cutouts, each said first cutout being positioned in said inner edge of a respective said jaw, wherein said first cutouts are opposingly positioned in said jaws, said first cutouts being semicircular, each said first cutout having a radius of 0.50 to 0.75 millimeters; and
a pair of second cutouts, each said second cutout being positioned in said inner edge of a respective said jaw, wherein said second cutouts are opposingly positioned in said jaws, said second cutouts being semicircular, each said second cutout having a radius of 0.35 to 0.55 millimeters.

5. The tool of claim 4, further including each said first cutout having a radius of 0.60 to 0.70 millimeters.

6. The tool of claim 4, further including each said second cutout having a radius of 0.40 to 0.50 millimeters.

7. The tool of claim 4, further including said pair of first cutouts being positioned distally from said pair of second cutouts relative to said first ends of said handles.

8. The tool of claim 1, further comprising:
a pair of pivot holes, each said pivot hole being positioned through a respective said handle proximate to said first end of said respective said handle; and
a pivot pin, said pivot pin being positioned through each of said pair of pivot holes, wherein opposing flared ends of said pivot pin retain said pivot pin within said pivot holes, such that said pair of handles is pivotally coupled.

9. The tool of claim 1, further including a pair of grips, each said grip being coupled to a respective said handle, wherein said grips are positioned on said handles such that said grips are configured to engage the fingers and a palm of a user's hand to prevent slippage of said handles.

10. The tool of claim 9, further including each said grip extending from a second end of a respective said handle to proximate to a midpoint of said respective said handle.

11. The tool of claim 4, further including a plurality of indicators, each said indicator being coupled to a respective said jaw proximate to a respective said grasp, wherein said indicator is positioned on said jaw to notify the user of the intended usage of said grasp.

12. The tool of claim 11, further including said plurality of indicators comprising:
“B” labels positioned proximate to said first cutout; and
“D” labels positioned proximate to said second cutouts.

13. The tool of claim 12, further including said “B” labels and said “D” labels being engraved.

14. The tool of claim 11, further including said plurality of indicators being positioned on opposing faces of a respective said jaw.
P. A cable grasping tool comprising:
a pair of handles, said handles being rigid, said handles being pivotally coupled, said handles being arcuate, such that said handles are opposing;
a pair of jaws, each said jaw being coupled to and extending from a first end of a respective said handle, each said jaw comprising:
an inner edge and, said inner edge being substantially straight, such that said inner edges are adjacently positionable when said handles are pivoted inwardly, and
an outer edge, said outer edge being arcuate;
a plurality of grasps, each said grasp being coupled to said inner edge of a respective said jaw, said grasps being configured to selectively couple a brake cable and a derailleur cable of a velocipede, each said grasp comprising a pair of cutouts, each said cutout being positioned in said inner edge of a respective said jaw, wherein said cutouts are opposingly positioned in said jaws, said cutouts being semicircular;
said plurality of grasps comprising:
a pair of first cutouts, each said first cutout being positioned in said inner edge of a respective said jaw, wherein said first cutouts are opposingly positioned in said jaws, said first cutouts being semicircular, each said first cutout having a radius of 0.50 to 0.75 millimeters, each said first cutout having a radius of 0.60 to 0.70 millimeters, and
a pair of second cutouts, each said second cutout being positioned in said inner edge of a respective said jaw, wherein said second cutouts are opposingly positioned in said jaws, said second cutouts being semicircular, each said second cutout having a radius of 0.35 to 0.55 millimeters, each said second cutout having a radius of 0.40 to 0.50 millimeters;
said pair of first cutouts being positioned distally from said pair of second cutouts relative to said first ends of said handles;
a pair of pivot holes, each said pivot hole being positioned through a respective said handle proximate to said first end of said respective said handle;
a pivot pin, said pivot pin being positioned through each of said pair of pivot holes, wherein opposing flared ends of said pivot pin retain said pivot pin within said pivot holes, such that said pair of handles is pivotally coupled;
a pair of grips, each said grip being coupled to a respective said handle, wherein said grips are positioned on said handles such that said grips are configured to engage the fingers and a palm of a user's hand to prevent slippage of said handles, each said grip extending from a second end of a respective said handle to proximate to a midpoint of said respective said handle;
a plurality of indicators, each said indicator being coupled to a respective said jaw proximate to a respective said grasp, wherein said indicator is positioned on said jaw to notify the user of the intended usage of said grasp, said plurality of indicators comprising “B” labels positioned proximate to said first cutouts and “D” labels positioned proximate to said second cutouts, said “B” labels and said “D” labels being engraved;
said plurality of indicators being positioned on opposing faces of a respective said jaw; and
wherein said handles are positionable with said jaws in an open configuration, such that a cable is insertable between said jaws, wherein said handles are configured for inward pivoting by action of a user's hand such that said pair of first cutouts is configured to engage a brake cable and said pair of second cutouts is configured to engage a derailleur cable to facilitate manipulation of brake and derailleur cables by the user.
